(19) United States
(12) Patent Application Publication
(10) Pub. No.: US 2019/0375299 A1
(43) Pub. Date: Dec. 12, 2019

(54) DUAL TEMPERATURE-MONITORING HEV CHARGER CORD AND ADAPTER ASSEMBLY

(71) Applicant: Ford Global Technologies, LLC, Dearborn, MI (US)

(72) Inventor: John Marshall PENNEY, Livonia, MI (US)

(21) Appl. No.: 16/001,191

(22) Filed: Jun. 6, 2018

(51) Int. Cl. B60L 11/18; H02J 7/00; H01R 31/06; H01R 13/66

(52) U.S. Cl. CPC B60L 11/1818; H02J 7/0029; H02J 7/007; H01R 31/065; H01R 24/30; B60L 2230/12; B60L 2240/36; H01R 2201/26; H01R 13/6683

(57) ABSTRACT

A vehicle charger assembly is provided. The vehicle charger assembly includes a plug including a first temperature sensor, and an adapter mechanically and electrically couplable to the plug and including a second temperature sensor. The vehicle charger assembly further includes a charge circuit interrupting device (CCID) in electrical communication with the plug and the adapter and adapted to reduce a charging current in response to a charging temperature associated with one or both of the first and second temperature sensors exceeding a threshold charging temperature.

### TECHNICAL FIELD

The present disclosure relates to a charging assembly and a thermal management system for charging an electric vehicle.

### BACKGROUND

Battery Electric Vehicles (BEVs) and plug-in hybrid electric vehicles (PHEVs) may require the use of an electric vehicle supplied equipment (EVSE) charger cord set which allows a vehicle operator to charge the vehicle in a garage or at other locations having a 110 VAC outlet, a 220 VAC outlet, or both a 110 VAC outlet and a 220 VAC outlet.

### SUMMARY

In at least one approach, a vehicle charger assembly is provided. The vehicle charger assembly may include a plug including a first temperature sensor, and an adapter mechanically and electrically couplable to the plug and including a second temperature sensor. The vehicle charger assembly may further include a charge circuit interrupting device (CCID) in electrical communication with the plug and the adapter and adapted to reduce a charging current in response to a charging temperature associated with one or both of the first and second temperature sensors exceeding a threshold charging temperature.

In at least one approach, a method for controlling vehicle charging is provided. The method may include, at a charge circuit interrupting device (CCID) that is electrically connected to a plug and an adapter electrically connected to the plug, monitoring a first charging temperature in the plug and a second charging temperature in the adapter. The method may further include, at the CCID, reducing a charging current in response to a charging temperature associated with one or both of the firstplug and second temperature sensorsthe adapter exceeding a threshold charging temperature.

In at least one approach, a vehicle charger assembly is provided. The vehicle charger assembly may include a plug including a first temperature sensor, and an adapter mechanically and electrically couplable to the plug and including a second temperature sensor. The vehicle charger assembly may further include a charge circuit interrupting device adapted to effect a signal to the first and second temperature sensors. The charge circuit interrupting device may further be adapted to terminate a charging current responsive to receiving a feedback signal indicative of an average of temperatures at the first and second temperature sensors exceeding a threshold temperature.

### BRIEF DESCRIPTION OF THE DRAWINGS

FIG. 1 is a schematic view of an electrified vehicle and a charging assembly.

FIG. 2 is perspective view of a plug and adapter for use with the charging assembly.

FIGS. 3A, 3B, 3C, and 3D are schematic views of prong arrangements for the adapter of FIG. 2.

FIG. 4 is a schematic view of a first charging assembly.

FIG. 5 is a schematic view of a second charging assembly.

FIG. 6 is a schematic view of a third charging assembly.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

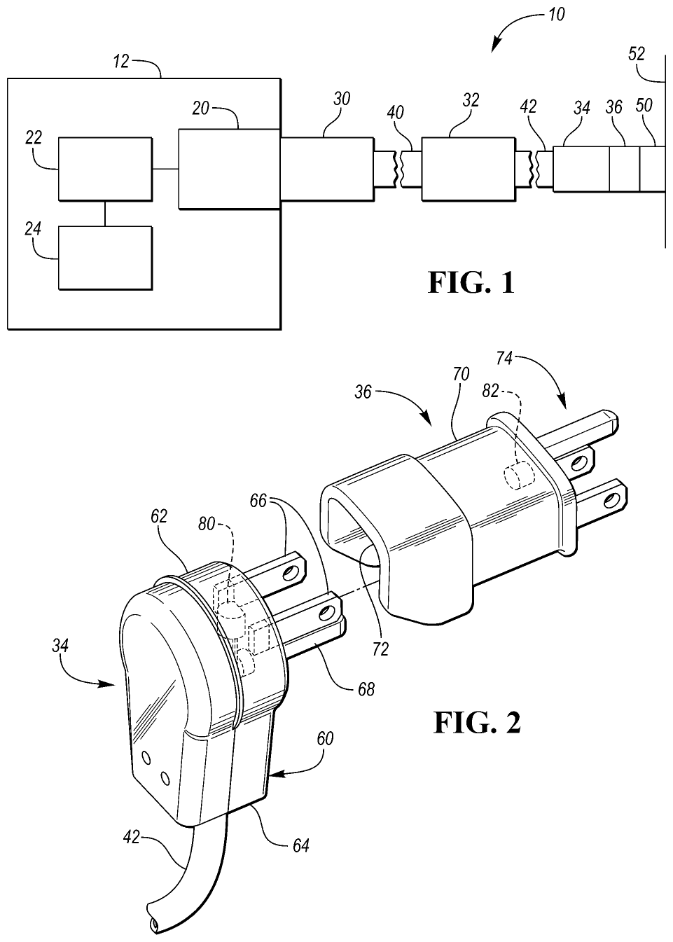

Referring to FIG. 1, a temperature monitoring electric vehicle (EV) charger cord assembly, referred to hereinafter as a charger assembly 10, may be provided for an electric vehicle 12. The electric vehicle 12 may be a BEV, PHEV, or other electrified vehicle having an energy management system. An energy management system may include a charging port 20, a battery energy control module (BECM) 22, and a battery 24. In such a vehicle, electrical current may flow through the charging port 20 and into the battery 24. The BECM 22 may act as a controller for one or more components of the energy management system. For example, the BECM 22 may be adapted to connect the vehicle 12 to an electrical source, such as a 110V source or 220V source, and to send the current received to the battery 24. The BECM 22 may include an electronic monitoring system that manages temperature and state of charge of the battery 24. The battery 24 may be a high voltage battery, or traction battery, that may output electrical power to operate a motor. The battery 24 may be a battery pack made up of one or more battery modules. Each battery module may contain one battery cell or a plurality of battery cells. The battery cells may be heated and cooled using a fluid coolant system, air coolant system, or other coolant method.

The charger assembly 10 may include a vehicle coupler 30, a circuit-interrupter 32 such as a charge circuit interrupting device (CCID), a plug 34, and an adapter 36. The vehicle coupler 30 may be a plug that interfaces the charging port 20 of the vehicle 12. By way of example, the coupler 18 can comprise a power link and communications interface that conforms to Society of Automotive Engineers (SAE) Electric Vehicle and Plug-in Hybrid Electric Vehicle Conductive Charge Coupler standard (J1772), hereinafter “SAE J1772.” The SAE J1772 standard provides a procedure for coupling an EV to an EVSE and for establishing and confirming connection between a high voltage link at an EV and a high voltage link at an EVSE.

A first wiring conduit 40 may extend between the vehicle coupler 30 and the circuit-interrupter 32 (e.g., from the vehicle coupler 30 to the circuit-interrupter 32). One or more components may be disposed between the vehicle coupler 30 and the circuit-interrupter 32 such that the first wiring conduit 40 does not directly engage the vehicle coupler 30, the circuit-interrupter 32, or either the vehicle coupler 30 or the circuit-interrupter 32.

A second wiring conduit 42 may extend between the circuit-interrupter 32 and the plug 34 (e.g., from the circuit-interrupter 32 to the plug 34). One or more components may be disposed between the circuit-interrupter 32 and the plug 34 such that the second wiring conduit 42 does not directly engage the circuit-interrupter 32, the plug 34, or either the circuit-interrupter 32 or the plug 34.

The charger assembly 10 may be configured such that either the plug 34 of the adapter 36 may be plugged into an outlet 50. The outlet 50 may be, for example, a wall outlet disposed on a wall 52. In this way, the outlet 50 may be installed in or on a wall 52 of a garage or other structure. In some applications, the outlet 50 may include a standard or conventional 110 VAC electrical socket. In still other applications, the outlet 50 may include a 220 VAC electrical socket. In still other applications, the outlet 50 may include both a 110 VAC electrical socket and a 220 VAC electrical socket.

Referring to FIG. 2, both the plug 34 and the adapter 36 may be adapted to mechanically and electrically interface with an outlet (e.g., outlet 50). The plug 34 may include a plug housing 60. The plug housing 60 may be plastic or other material and may include a sensor housing portion 62 and a housing extension portion 64 that extends from the sensor housing portion 62. A pair of spaced-apart power prongs 66, each of which is an electrically-conductive material, may extends from the sensor housing portion 62. An electrically-conductive ground prong 68 may extend from the sensor housing portion 62 generally between and in spaced-apart relationship to the power prongs 66.

The plug 34 may be a 120 VAC plug, and may be a NEMA 5-15 connector. In this way, the plug 34 may permit Level 1 charging. Such plugs may allow drivers to charge wherever a suitable outlet is available. A Level 1, 120 VAC charger may provide, for example, 16 amps or 1.92 kW, and may add, for example, two to five miles of electric range for every hour of charging.

The adapter 36 may include an adapter housing 70. The adapter housing 70 may include or define a receptacle 72 that may be adapted to receive at least a portion of the plug 34. For example, the receptacle 72 may receive the power prongs 66 and the ground prong 68 such that the plug 34 may be mechanically and electrically coupled to the adapter 36. The adapter 36 may further include a prong interface 74.

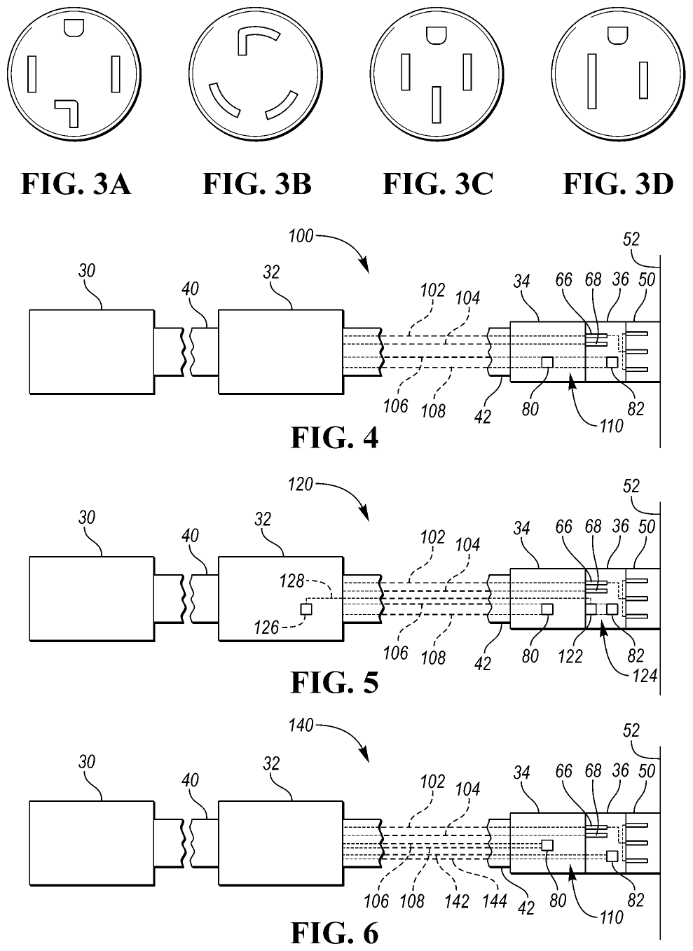

The prong interface 74 may include one or more prongs disposed in a suitable arrangement. For example, the prongs may be disposed in an arrangement corresponding to a NEMA 14-30 arrangement (e.g., as shown in FIG. 3A), a NEMA L6-30 arrangement (e.g., as shown in FIG. 3B), a NEMA 14-50 arrangement (e.g., as shown in FIG. 3C), a NEMA 6-50 arrangement (e.g., as shown in FIG. 3D), or other suitable NEMA arrangement.

In this way, the adapter may permit Level 2 charging. A Level 2, 240 VAC charger may provide, for example, 80 amps or 19.2 kW, and may add, for example, ten to 25 miles of electric range for every hour of charging.

Referring again to FIG. 2, the plug 34 may include at least one thermal sensor 80. The thermal sensor 80 may be provided in the sensor housing portion 62 of the plug housing 60. The thermal sensor 80 may include a device or material that is capable of sensing an elevation in temperature inside the sensor housing portion 60. In at least one approach, the thermal sensor 80 may include at least one thermistor, which is a type of resistor in which the resistance varies with temperature. The thermistor may include a ceramic or polymer material. In at least one approach, the thermal sensor 80 may be disposed between the power prongs 66 inside the sensor housing portion 62 of the plug housing 60.

The adapter 36 may also include at least one thermal sensor 82. The thermal sensor 82 may be provided in the adapter housing 70. The thermal sensor 82 may also include a device or material that is capable of sensing an elevation in temperature inside the adapter housing 70. In at least one approach, the thermal sensor 82 may include at least one thermistor, that may include a ceramic or polymer material.

Referring to FIG. 4, a vehicle charger assembly 100 is provided. The vehicle charger assembly 100 includes many of the features of the charger assembly 10. As such, like reference will be used to indicate like components.

The charger assembly 100 may include a plug 34 and an adapter 36. The adapter 36 may be mechanically and electrically couplable to the plug 34. The plug 34 may include a first temperature sensor 80, and the adapter 36 may include a second temperature sensor 82. In at least one approach, the first temperature sensor 80 is a first thermistor, and the second temperature sensor 82 is a second thermistor. One or both of the first and second temperature sensors 80, 82 may be a ceramic or polymer material.

The charger assembly 100 may further include a circuit-interrupter 32 such as a charge circuit interrupting device (CCID). The circuit-interrupter 32 may be in electrical communication with the plug 34 and the adapter 36. The circuit-interrupter 32 may be adapted to reduce a charging current in response to a charging temperature associated with one or both of the first and second temperature sensors 80, 82 exceeding a threshold charging temperature. As used herein, a temperature (or average temperature, or other temperature function) “exceeds” the threshold charging temperature when the temperature elevates above the threshold charging temperature. Reduction of the charging current may include reducing the charging current from a first amperage to a second amperage that is less than the first amperage. The second amperage may be such that the plug (or plug and receptacle) interfaces of the plug 34 and the adapter 36 may reduce over time. In at least one approach, the second amperage is zero amps such that the charging current through the charger assembly 100 is terminated.

The circuit-interrupter 32 may be electrically connected to the power prongs 66, as indicated by dashed line 102, and may be electrically connected to the ground prong 68, as indicated by dashed line 104.

The circuit-interrupter 32 may be adapted to effect a thermocouple signal to the first temperature sensor 80, the second temperature sensor 82, or both the first and second temperature sensors 80, 82. As such, the circuit-interrupter 32 may be adapted to effect a thermocouple signal to at least the first temperature sensor 80, as indicated by dashed line 106. The circuit-interrupter 32 may further be adapted to receive a thermocouple feedback signal to the first temperature sensor 80, the second temperature sensor 82, or both the first and second temperature sensors 80, 82. As such, the circuit-interrupter 32 may be adapted to receive a thermocouple feedback signal to at least the first temperature sensor 80, as indicated by dashed line 108.

As shown in the approach of FIG. 4, the first and second thermistors may be electrically connected in parallel, as generally indicated at 110. The circuit-interrupter 32 may be adapted to effect the thermocouple signal 106 to the first and second temperature sensors 80, 82. The circuit-interrupter 32 may further be adapted to receive the thermocouple feedback signal 108 from the first and second thermistors. The circuit-interrupter 32 may further be adapted to reduce the charging current in response to an average charging temperature associated with the first and second temperature sensors 80, 82 exceeding the threshold charging temperature.

Referring now to FIG. 5, a charger assembly 120 may include an adapter 36. The adapter 36 may further include an encoder 122 that may be disposed within an adapter housing (e.g., the adapter housing 70 of FIG. 2). The encoder 122 may be adapted to effect a thermocouple signal to the second temperature sensor 82, and to receive a thermocouple feedback signal from the second temperature sensor 82, as generally indicated at 124. In this way, the encoder 122 may be adapted to sense a temperature at the second temperature sensor 82. The encoder may further be adapted to effect a signal indicative of the temperature at the second temperature sensor 82.

The circuit-interrupter 32 may further include a decoder 126 that may be disposed within the circuit-interrupter 32 housing. The decoder 126 may be in electrical communication with the encoder 122, as indicated by dashed line 128. In this way, the circuit-interrupter 32 (e.g., at the decoder 26) may be adapted to receive the signal indicative of a temperature at the second temperature sensor 82. In this way, the circuit-interrupter 32 may be adapted to reduce the charging current in response to the temperature at the first temperature sensor 80, the second temperature sensor 82, or at both the first and second temperature sensors 80, 82 exceeding the threshold temperature.

Referring now to FIG. 6, a charger assembly 140 may include a circuit-interrupter 32 that may be adapted to effect a first thermocouple signal to the first temperature sensor 80, as indicated by dashed line 106, and may be adapted to receive a first thermocouple feedback signal from the first temperature sensor 80, as indicated by dashed line 108. The circuit-interrupter 32 may be adapted to effect a second thermocouple signal to the second temperature sensor 82, as indicated by dashed line 142, and may be adapted to receive a second thermocouple feedback signal from the second temperature sensor 82, as indicated by dashed line 144. The first thermocouple signal 106 and the second thermocouple signal 142 may be independent thermocouple signals. In this way, the circuit-interrupter 32 may be adapted to reduce the charging current in response to the temperature at the first temperature sensor 80, the second temperature sensor 82, or at both the first and second temperature sensors 80, 82 exceeding the threshold temperature.

In at least one approach, a method for controlling vehicle charging is provided. The method may include, at a charge circuit interrupting device (CCID) that is electrically connected to a plug and an adapter electrically connected to the plug, monitoring a first charging temperature in the plug and a second charging temperature in the adapter. The method may further include, at the CCID, reducing a charging current in response to a charging temperature associated with one or both of the first and second temperature sensors exceeding a threshold charging temperature.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle charger assembly comprising:
a plug including a first temperature sensor;
an adapter mechanically and electrically couplable to the plug and including a second temperature sensor; and
a charge circuit interrupting device (CCID) in electrical communication with the plug and the adapter and adapted to reduce a charging current in response to a charging temperature associated with one or both of the first and second temperature sensors exceeding a threshold charging temperature.

2. The vehicle charger assembly of claim 1 wherein the first temperature sensor is a first thermistor, wherein the second temperature sensor is a second thermistor, and wherein the CCID is adapted to effect a thermocouple signal to at least the first thermistor, and to receive a thermocouple feedback signal from at least the first thermistor.

3. The vehicle charger assembly of claim 2 wherein the first and second thermistors are electrically connected in parallel, and wherein the CCID is adapted to effect the thermocouple signal to the first and second thermistors, and to receive the thermocouple feedback signal from the first and second thermistors.

4. The vehicle charger assembly of claim 3 wherein the charging temperature is an average charging temperature associated with the first and second thermistors, and wherein the CCID is adapted to reduce the charging current in response to the average charging temperature exceeding the threshold charging temperature.

5. The vehicle charger assembly of claim 2 wherein the adapter further comprises an encoder disposed within an adapter housing of the adapter and adapted to effect a thermocouple signal to the second thermistor, to receive a thermocouple feedback signal from the second thermistor, and to effect a signal indicative of a temperature at the second thermistor.

6. The vehicle charger assembly of claim 5 wherein the CCID further comprises a decoder disposed within a CCID housing and adapted to receive the signal indicative of a temperature at the second thermistor and to reduce the charging current in response to the temperature at the second thermistor exceeding the threshold temperature.

7. The vehicle charger assembly of claim 2 wherein the CCID is adapted to effect a first thermocouple signal to the first thermistor and a second thermocouple signal to the second thermistor, and to receive a first thermocouple feedback signal from the first thermistor and a second thermocouple feedback signal from the second thermistor.

8. The vehicle charger assembly of claim 7 wherein the first thermocouple signal and the second thermocouple signals are independent thermocouple signals.

9. The vehicle charger assembly of claim 2 wherein the first and second thermistors are a ceramic or polymer material.

10. The vehicle charger assembly of claim 1 wherein the CCID is adapted to reduce the charging current by terminating the charging current.

11. A method for controlling vehicle charging comprising:
at a charge circuit interrupting device (CCID) that is electrically connected to a plug and to an adapter electrically connected to the plug,
monitoring a first charging temperature in the plug and a second charging temperature in the adapter; and
reducing a charging current in response to the first charging temperature or the second charging temperature exceeding a threshold charging temperature.

12. The method of claim 11 wherein the plug includes a first temperature sensor and wherein the adapter includes a second temperature sensor.

13. The method of claim 12 wherein the first temperature sensor is a first thermistor, wherein the second temperature sensor is a second thermistor, and wherein the method further includes:
at the CCID,
effecting a thermocouple signal to at least the first thermistor; and
receiving a thermocouple feedback signal from at least the first thermistor.

14. The method of claim 13 wherein the first and second thermistors are electrically connected in parallel, and wherein the method includes:
at the CCID,
effecting the thermocouple signal to the first and second thermistors; and
receiving the thermocouple feedback signal from the first and second thermistors.

15. The method of claim 14 wherein the charging temperature is an average charging temperature associated with the first and second thermistors, and wherein the method further includes:
at the CCID, reducing the charging current in response to the average charging temperature exceeding the threshold charging temperature.

16. The method of claim 13 wherein the adapter further comprises an encoder disposed within an adapter housing of the adapter, and wherein the method further includes:
at the encoder,
effecting a thermocouple signal to the second thermistor;
receiving a thermocouple feedback signal from the second thermistor; and
effecting a signal indicative of a temperature at the second thermistor.

17. The method of claim 16 wherein the CCID further comprises a decoder disposed within a CCID housing, and wherein the method further includes:
at the CCID,
receiving the signal indicative of a temperature at the second thermistor; and
responsive to the temperature at the second thermistor exceeding the threshold temperature, reducing the charging current.

18. The method of claim 13 further comprising:
at the CCID,
effecting a first thermocouple signal to the first thermistor;
receiving a first thermocouple feedback signal from the first thermistor;
effecting a second thermocouple signal to the second thermistor; and
receiving a second thermocouple feedback signal from the second thermistor.

19. The method of claim 18 wherein the first thermocouple signal and the second thermocouple signals are independent thermocouple signals.

20. A vehicle charger assembly comprising:
a plug including a first temperature sensor;
an adapter mechanically and electrically couplable to the plug and including a second temperature sensor; and
a charge circuit interrupting device adapted to effect a signal to the first and second temperature sensors, and adapted to terminate a charging current responsive to receiving a feedback signal indicative of an average of temperatures at the first and second temperature sensors exceeding a threshold temperature.
